(19) United States
(12) Patent Application Publication
(10) Pub. No.: US 2020/0245640 A1
(43) Pub. Date: Aug. 6, 2020

(54) USE OF ENZYMES TO DEFLAVOR PEA PROTEIN

(71) Applicant: MycoTechnology, Inc., Aurora, CO (US)

(72) Inventors: Anthony J. CLARK, Aurora, CO (US); Marina NADAL, Aurora, CO (US); Zheyuan GUO, Aurora, CO (US)

(73) Assignee: MycoTechnology, Inc., Aurora, CO (US)

(21) Appl. No.: 16/780,404

(22) Filed: Feb. 3, 2020

Related U.S. Application Data
(60) Provisional application No. 62/800,313, filed on Feb. 1, 2019.

(51) Int. Cl. A23J 1/14; A23J 3/14; A23J 3/22

(52) U.S. Cl. CPC A23J 1/148; A23J 3/227; A23J 3/14

(57) ABSTRACT

Provided is a method for producing a plant protein product which includes treating the plant protein with at least one an exogenous enzyme comprising an oxidoreductase and/or a hydrolase. The method results in a treated protein product that has reduced undesirable aromas and/or reduced undesirable tastes, compared to an untreated plant protein product. In a further embodiment, the method further includes mixing the treated protein product with another material to form a food composition. Also provided are compositions made by the methods of the invention.

### CROSS REFERENCE TO RELATED APPLICATIONS

This patent application claims priority to and the benefit of U.S. Provisional Application Ser. No. 62/800,313, filed Feb. 1, 2019, the entirety of which is incorporated herein by reference.

### BACKGROUND OF THE INVENTION

Plant protein products, such as pea protein concentrates and pea protein isolates, are used as ingredients in a large number of products. The functional properties of plant protein products are important for their quality as ingredients. Important functional properties are properties like water binding, ability to impart textural properties, flavor and taste. In the current food market, there is a huge demand for plant protein products with improved functional properties, e.g. improved ability to impart textural properties such as viscosity to food products.

There is also a growing need for efficient, high quality and low-cost plant protein food sources with acceptable taste, flavor and/or aroma profiles. However, it has proven difficult to achieve such products, particularly with low cost vegetarian protein sources.

### SUMMARY OF THE INVENTION

The present invention provides a method for producing a plant protein product comprising treating the plant protein with at least one an exogenous enzyme comprising an oxidoreductase and/or a hydrolase. The method results in a treated protein product that has reduced undesirable aromas and/or reduced undesirable tastes, or improved properties such as water and/or oil-holding capacities, compared to an untreated plant protein product. In a further embodiment, the method further includes mixing the treated protein product with another material to form a food composition.

In an embodiment, the oxidoreductase or the hydrolase can include one or more of 6-hydroxy-D-nicotine oxidase, exoglucanases, cytochrome p450, endo-1,4-beta-xylanase C, benzoate 4-monooxygenase, endo-1,4-beta-xylanase C, endo-beta-1,4-glucanase D, laccase-2, laccase, beta-galactosidase, xyloglucan-specific endo-beta-1,4-glucanase A, endopolygalacturonase A, endo-1,4-beta-xylanase C, glycolipid 2-alpha, mannosyltransferase 2, beta-glucosidase A, or glucan 1,3-beta-glucosidase.

In an embodiment, the present invention includes compositions made by the methods of the invention.

### DETAILED DESCRIPTION OF THE INVENTION

The present inventors have found that treating a plant protein in, e.g., an aqueous solution can alter the taste, flavor or aroma of plant proteins in unexpected ways. The process additionally enables the production of protein concentrates, isolates and high protein foodstuffs that have an improved viscosity of a solution, or improved suspension of the plant protein or increase the water holding capacity and/or water binding of a solution or suspension of the plant protein. The present invention also presents the ability to stack protein sources to optimize amino acid profiles of products made according to the methods of the invention.

In an embodiment, the present invention includes a method for producing a plant protein product comprising treating the plant protein with at least one exogenous enzyme, optionally, a purified enzyme preparation, comprising an exogenous enzyme, in particular, an enzyme from the class of oxidoreductase and/or hydrolase, wherein the plant protein product has reduced undesirable flavors and reduced undesirable aromas compared to an untreated plant protein product.

### Oxidoreductases

An oxidoreductase may be any oxidoreductase described by the enzyme classification EC 1 as set out by the Nomenclature Committee of the International Union of Biochemistry and Molecular Biology (IUBMB), or any fragment derived therefrom exhibiting oxidoreductase activity. In one embodiment of the invention, an oxidoreductase is an oxidoreductase acting on diphenols and related substances as donors comprised by the enzyme classification EC 1.10, such as a laccase (EC 1.10.3.2), an o-aminophenol oxidase (EC 1.10.3.4), or a catechol oxidase (EC 1.10.3.1); or an oxidoreductase acting on CH-OH groups of donors described by the enzyme classification EC 1.1, such as a peroxidase, a glucose oxidase (EC 1.1.3.4), a hexose oxidase (EC 1.1.3.5), or a cellobiose oxidase (EC 1.1.3.25). In one embodiment of the invention, the plant protein is treated with a combination of two or more oxidoreductases, e.g. a combination of a peroxidase and a glucose oxidase (EC 1.1.3.4), a hexose oxidase (EC 1.1.3.5), or a cellobiose oxidase (EC 1.1.3.25). In a further embodiment of the invention, the oxidoreductase is a lipoxygenase (EC 1.13.11.12).

An oxidoreductase may be of any origin, e.g. of microbial origin. The enzyme may e.g. be derived from animals, plants, bacteria or fungi (including filamentous fungi and yeasts).

Suitable examples of oxidoreductases include, for example, laccases, benzoate 4-monooxygenase, 6-hydroxy-D-nicotine oxidase, cytochrome p450, and the like. In one embodiment, the endogenous enzyme is a laccase. In one embodiment, the oxidoreductase is obtained from a fungal source which include Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinus, e.g., C. cinereus, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radita (WO 92/01046), or Coholus, e.g., C. hirsutus (JP 2-238885).

Suitable examples of laccases from bacteria also include a laccase derivable from a strain of Bacillus.

The oxidoreductase may furthermore be one which is producible by a method comprising cultivating a host cell transformed with a recombinant DNA vector which carries a DNA sequence encoding said oxidoreductase as well as DNA sequences encoding functions permitting the expression of the DNA sequence encoding the oxidoreductase, in a culture medium under conditions permitting the expression of the oxidoreductase enzyme, and recovering the oxidoreductase from the culture.

Laccase activity (particularly suitable for Polyporus laccases) may be determined from the oxidation of syringaldazin under aerobic conditions. The violet color produced is measured with a spectrophotometer at 530 nm. The analytical conditions are 19 mM syringaldazin, 23 mM acetate buffer, pH 5.5, 30° C., 1 min. reaction time. 1 laccase unit (LACU) is the amount of enzyme that catalyses the conversion of 1.0 micromole syringaldazin per minute at these conditions. Laccase activity may also be determined from the oxidation of syringaldazin under aerobic conditions. The violet colour produced is measured at 530 nm. The analytical conditions are 19 mM syringaldazin, 23 mM Tris/maleate buffer, pH 7.5, 30° C., 1 min. reaction time. 1 laccase unit (LAMU) is the amount of enzyme that catalyses the conversion of 1.0 micromole syringaldazin per minute at these conditions.

The source of oxygen required by the oxidoreductase may be oxygen from the atmosphere or an oxygen precursor for in situ production of oxygen. Oxygen from the atmosphere will usually be present in sufficient quantity. If more O₂ is needed, additional oxygen may be added, e.g. as pressurized atmospheric air or as pure pressurized O₂.

### Hydrolases

Hydrolases are a class of enzyme that commonly perform as biochemical catalysts that use water to break a chemical bond, which typically results in dividing a larger molecule to smaller molecules. Hydrolases are classified as EC 3 in the EC number classification of enzymes. Hydrolases can be further classified into several subclasses, based upon the bonds they act upon: EC 3.1: ester bonds (esterases: nucleases, phosphodiesterases, lipase, phosphatase); EC 3.2: sugars (DNA glycosylases, glycoside hydrolase); EC 3.3: ether bonds; EC 3.4: peptide bonds (Proteases/peptidases); EC 3.5: carbon-nitrogen bonds, other than peptide bonds; EC 3.6 acid anhydrides (acid anhydride hydrolases, including helicases and GTPase); EC 3.7 carbon-carbon bonds; EC 3.8 halide bonds; EC 3.9: phosphorus-nitrogen bonds; EC 3.10: sulphur-nitrogen bonds; EC 3.11: carbon-phosphorus bonds; EC 3.12: sulfur-sulfur bonds; EC 3.13: carbon-sulfur bonds.

In another embodiment, the enzyme may be a transferase, such as glycolipid 2-alpha-mannosyltransferase 2.

A hydrolase may be of any origin, e.g. of microbial origin. The enzyme may e.g. be derived from animals, plants, bacteria or fungi (including filamentous fungi and yeasts).

Suitable examples of a hydrolase includes a hydrolase that breaks down sugars, such as, for example, an exoglucanase, an endo-1,4-beta-xylanase such as C, D; beta-galactosidase; xyloglucan-specific endo-beta-1,4-glucanase A, endopolygalacturonase A, endo-1,4-beta-xylanase C, beta-glucosidase A, glucan-1,3-beta-glucosidase.

In one embodiment, the hydrolase is obtained from a fungal source which include Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinus, e.g., C. cinereus, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radita (WO 92/01046), or Coholus, e.g., C. hirsutus (JP 2-238885).

The hydrolase may furthermore be one which is producible by a method comprising cultivating a host cell transformed with a recombinant DNA vector which carries a DNA sequence encoding said oxidoreductase as well as DNA sequences encoding functions permitting the expression of the DNA sequence encoding the hydrolase, in a culture medium under conditions permitting the expression of the hydrolase enzyme, and recovering the hydrolase from the culture.

The plant protein material used in the present invention, may be modified to enhance the characteristics of the plant protein material. The modifications are modifications which are known in the art to improve the utility or characteristics of a protein material and include, but are not limited to, denaturation and hydrolysis of the protein material.

The plant protein to use, e.g., to include in the aqueous solution can be obtained from a number of sources, including vegetarian sources (e.g., plant sources) as well as non-vegetarian sources, and can include a protein concentrate and/or isolate. Vegetarian sources include meal, protein concentrates and isolates prepared from a vegetarian source such as pea, rice, soy, cyanobacteria, grain, hemp, chia, chickpea, potato protein, algal protein and nettle protein or combinations of these. In embodiments, the vegetarian source is pea, rice, chickpea or a combination thereof. In embodiments, the vegetarian source is pea, chickpea or a combination thereof. In embodiments, the vegetarian source is rice, chickpea, or a combination thereof. For example, cyanobacteria containing more than 50% protein can also be used a source of plant protein material. Typically, a protein concentrate is made by removing the oil and most of the soluble sugars from a meal, such as soybean meal. Such a protein concentrate may still contain a significant portion of non-protein material, such as fiber. Typically, protein concentrations in such products are between 55-90%. The process for production of a protein isolate typically removes most of the non-protein material such as fiber and may contain up to about 90-99% protein. A typical protein isolate is typically subsequently dried and is available in a powdered form and may alternatively be called “protein powder.”

In one embodiment, mixtures of any of the plant protein materials disclosed can be used to provide, for example, favorable qualities, such as a more complete (in terms of amino acid composition) plant protein material. In one embodiment, plant protein materials such as pea protein and rice protein can be combined. In one embodiment, the ratio of a mixture can be from 1:10 to 10:1 pea protein: rice protein (on a dry basis). In one embodiment, the ratios can optionally be 5:1 to 1:5, 2:1 to 1:2, or in one embodiment, 1:1.

The plant protein itself can be about 20% protein, 30% protein, 40% protein, 45% protein, 50% protein, 55% protein, 60% protein, 65% protein, 70% protein, 75% protein, 80% protein, 85% protein, 90% protein, 95% protein, or 98% protein, or at least about 20% protein, at least about 30% protein, at least about 40% protein, at least about 45% protein, at least about 50% protein, at least about 55% protein, at least about 60% protein, at least about 65% protein, at least about 70% protein, at least about 75% protein, at least about 80% protein, at least about 85% protein, at least about 90% protein, at least about 95% protein, or at least about 98% protein, all by dry weight percent.

In some embodiments, the total protein in aqueous solution is about 15 g to about 100 g, or about 20-100 g of protein per 100 g dry weight.

In another embodiment, the aqueous solution comprises between about 1 g/L and 200 g/L solids or protein, between about 5 g/L and 180 g/L, between about 20 g/L and 150 g/L, between about 25 g/L and about 140 g/L, between about 30 g/L and about 130 g/L, between about 35 g/L and about 120 g/L, between about 40 g/L and about 110 g/L, between about 45 g/L and about 105 g/L, between about 50 g/L and about 100 g/L, between about 55 g/L and about 90 g/L, or about 75 g/L protein; or between about 50 g/L-150 g/L, or about 75 g/L and about 120 g/L, or about 85 g/L and about 100 g/L. Alternatively, the aqueous solution comprises at least about 10 g/L, at least about 15 g/L, at least about 20 g/L, at least about 25 g/L, at least about 30 g/L, at least about 35 g/L, at least about 40 g/L or at least about 45 g/L protein. In fermenters, in some embodiments the amount to use includes between about 1 g/L and 150 g/L, between about 10 g/L and 140 g/L, between about 20 g/L and 130 g/L, between about 30 g/L and about 120 g/L, between about 40 g/L and about 110 g/L, between about 50 g/L and about 100 g/L, between about 60 g/L and about 90 g/L, between about 70 g/L and about 80 g/L, or at least about 20 g/L, at least about 30 g/L, at least about 40 g/L, at least about 50 g/L, at least about 60 g/L, at least about 70 g/L, at least about 80 g/L, at least about 90 g/L, at least about 100 g/L, at least about 110 g/L, at least about 120 g/L, at least about 130 g/L or at least about 140 g/L. All amounts refer to g solids or proteins per ml solution.

### Treatment with Endogenous Enzyme

The plant protein to be treated may be in an aqueous suspension. An aqueous suspension may be prepared by mixing a plant protein preparation with water. Additional ingredients, such as salts, may be added depending on the desired properties of the final product. The pH and ionic strength of the aqueous suspension may be controlled to provide suitable conditions for the endogenous enzyme to be active, depending on the desired properties of the final plant protein product. In one embodiment of the invention, an aqueous preparation of plant protein containing at least 50%, preferably at least 60%, more preferably at least 70%, and more preferably at least 80%, plant protein (weight/weight) in dry matter is treated with an endogenous enzyme. In another embodiment, an aqueous suspension of plant protein concentrate and/or plant protein isolate is treated with an endogenous enzyme.

The treatment with endogenous enzyme may be effected by adding the endogenous enzyme, as a dry product, a suspension, or a solution to an aqueous solution or suspension of plant protein. The endogenous enzyme may be mixed into the solution or suspension of plant protein by any appropriate means known in the art. Additionally a mediator may be added. A mediator may be any substance suitable for enhancing the action of the endogenous enzyme on the plant protein, such as tyrosine.

Treatment of plant protein with an endogenous enzyme according to the invention may be performed in the presence of carbohydrates, lipids, hydrogen peroxide, other proteins, and mixtures thereof.

The temperature of the endogenous enzyme treatment may be any temperature suitable for ensuring the activity of the specific endogenous enzyme used. Typically, the range is between 50° C. and 100° C. The temperature may be chosen by the skilled person by methods well known in the art. In one embodiment of the invention, plant protein is treated with an endogenous enzyme at a temperature between 5° C. and 100° C., preferably between 10° C. and 80° C., and more preferably between 50° C. and 70° C. Similarly, the treatment of plant protein with an endogenous enzyme may be performed at a pH chosen by methods known in the art depending on the specific enzyme and/or plant protein material. In one embodiment of the invention, plant protein is treated with an endogenous enzyme at a pH between 2 and 10, preferably between 4 and 9, more preferably between 6 and 8. The duration of the treatment may be any duration suitable for obtaining the desired result. Typically, the duration of the treatment of plant protein with endogenous enzyme is between 5 minutes and 5 hours. In one embodiment, the duration of the treatment of plant protein with an endogenous enzyme is between 5 minutes and 5 hours, preferably between 10 minutes and 2 hours. The amount of endogenous enzyme used may be chosen so as to achieve the desired result. Typically, the amount of endogenous enzyme used is between 0.5 LAMU/g plant product and 4.0 LAMU/g plant product. The amount depends on the activity of the specific endogenous enzyme towards the specific plant protein substrate, along with the temperature, duration, and other conditions of the endogenous enzyme treatment.

In another embodiment of the invention, plant protein is treated with an amount of endogenous enzyme and for a time sufficient to lead to an increase in water holding capacity of the treated plant protein preparation compared to similar untreated plant protein. Typically the plant protein is treated with between 0.5 LAMU/g plant product and 4.0 LAMU/g plant product (when the endogenous enzyme is laccase) of endogenous enzyme for at least 30 minutes at a temperature of between 40° C. and 70° C., in order to increase the water holding capacity of the treated plant protein preparation.

In one embodiment the invention relates to use of at least one endogenous enzyme to treat plant protein concentrate and/or plant protein isolate to increase the water holding capacity and/or water binding of the plant protein concentrate and/or plant protein isolate. In a further embodiment the invention relates to use of at least one to treat plant protein concentrate and/or plant protein isolate to increase the viscosity of a solution or suspension of the plant protein concentrate and/or plant protein isolate.

After treatment, the plant protein product can be processed according to a variety of methods. In one embodiment, the plant protein product is pasteurized or sterilized. In one embodiment, the plant protein product is dried according to methods as known in the art. Additionally, concentrates and isolates of the material may be prepared using variety of solvents or other processing techniques known in the art. In one embodiment the material is pasteurized or sterilized, dried and powdered by methods known in the art. Drying can be done in a desiccator, vacuum dryer, conical dryer, spray dryer, fluid bed or any method known in the art. Preferably, methods are chosen that yield a dried plant protein product (e.g., a powder) with the greatest digestibility and bioavailability. The dried plant protein product can be optionally blended, pestled milled or pulverized, or other methods as known in the art.

### Functional Properties of Plant Protein Preparation of the Invention

The plant protein preparation of the invention has improved properties compared to a similar plant protein product that has not been treated with an endogenous enzyme. In one embodiment, the viscosity of a suspension of the plant protein preparation is higher than a similar suspension that has not been treated with an endogenous enzyme. Typically when the endogenous enzyme is a laccase, the plant protein is treated with between 0.5 LAMU/g plant product and 4.0 LAMU/g plant product of endogenous enzyme for at least 30 minutes at a temperature of between 40° C. and 70° C., in order to increase the viscosity of the treated plant protein preparation. Viscosity may be increased by at least 2%, preferably at least 3%, and more preferably at least 5%, compared to a similar plant protein product that has not been treated with an endogenous enzyme. Viscosity may be measured by methods well known in the art, e.g. by rotary viscometry. In another embodiment, the taste of the plant protein preparation is improved. In still another embodiment, the water holding capacity of the plant protein preparation is increased compared to a similar plant protein preparation that has not been treated with an endogenous enzyme. Inclusion of a plant protein preparation according to the invention in a food product may increase the water holding capacity of the food product compared to a similar food product comprising an equal amount of a similar plant protein preparation produced without treatment with an endogenous enzyme. Water holding capacity is the ability of a material to hold its own and/or added water during the application of forces, pressing, and/or heating. Water holding capacity may be evaluated by measurement of viscosity, by the method furnished by AACC (American Association of Cereal Chemists) Technical Committee, as described in Cereal Foods World (1981) 26:291, and/or by the method described in the examples following hereafter. In one embodiment of the invention, the water binding of the plant protein product is improved by the treatment with an endogenous enzyme. The amount of bound water may be determined by ¹HNMR as described by H. C. Bertram et al, J. Agric. Food Chem., 50, 824-829 (2002) and in the examples following hereafter.

Treatment of plant protein with endogenous enzyme may lead to crosslinking of plant protein molecules, e.g. by formation of dityrosine.

In many cases, the flavor, taste and/or aroma of plant proteins as disclosed herein, such as protein concentrates or isolates from vegetarian sources may have flavors, which are often perceived as unpleasant, having pungent aromas and bitter or astringent tastes. These undesirable flavors and tastes are associated with their source(s) and/or their processing, and these flavors or tastes can be difficult or impossible to mask or disguise with other flavoring agents. The present invention, as explained in more detail below, works to modulate these tastes and/or flavors.

In one embodiment of the invention, flavors and/or tastes of the plant protein product or products are modulated as compared to the plant protein (starting material). In one embodiment, the aromas of the resultant plant protein food products prepared according to the invention are reduced and/or improved as compared to the starting material. In other words, undesired aromas are reduced and/or desired aromas are increased. In another embodiment, flavors and/or tastes may be reduced and/or improved.

Aromas, and/or tastes of plant protein food products may also be improved by processes of the current invention. For example, deflavoring can be achieved, resulting in a milder aroma or flavor and/or with the reduction of, for example, bitter and/or astringent flavors and/or beany and/or weedy and/or grassy aromas and/or flavors. The decrease in undesirable flavors and/or tastes as disclosed herein may be rated as an decrease of 1 or more out of a scale of 5 (1 being none, 5 being very strong.)

Incubation times and/or conditions can be adjusted to achieve the desired aroma, flavor and/or taste outcomes and can be determined by one of skill in the art and/or are disclosed as described previously herein. As compared to the control and/or starting plant protein, and/or the pasteurized, dried and powdered medium not subjected to treatment with an endogenous enzyme, the resulting plant protein food product in some embodiments is less bitter and has a more mild, less beany aroma.

### Food Product

In one embodiment, the invention relates to a method for producing a food product comprising mixing a plant protein preparation of the invention with additional food ingredients and producing a food product from the mixture. A food product of the invention may be any food product, e.g. a meat product, a dairy product, a vegetable product, fruit product, a ready to eat product, and mixtures thereof. A food product of the invention may also be a component of a food used to impart desired form or structure, enhance texture, or improve convenience in use, e.g. an edible film, coating or casing.

Plant protein is well known in the art as an ingredient of or an additive to a number of different food products. A plant protein preparation according to the invention may be used as an ingredient in a food product in the same way as other plant protein products are usually used. A food product comprising a plant protein preparation according to the invention may be produced in the same manner as a food product comprising a conventional plant protein product. A plant protein preparation according to the invention may be added in the same way and in the same amounts as a conventional plant protein product is added to a similar food product. A meat product according to the invention may be a whole meat product or a processed meat product, such as sausage, meat loaf, comminuted meat product, ground meat, bacon, baloney, salami, or pate. A processed meat product may further comprise salts, spices, milk protein, vegetable ingredients, coloring agents, texturizing agents, and mixtures thereof. A processed meat product may be an emulsified meat product, manufactured from a meat-based emulsion. The meat-based emulsion may be cooked or baked in a baking form or after being filled into casing of plastic, collagen, cellulose, or natural casing. A processed meat product may also be a restructured meat product, such as restructured ham. A meat product of the invention may undergo at least one of the following processing steps: curing, drying, smoking, fermentation, cooking, slicing, and/or shredding. A meat-based food product may be produced by contacting meat with a plant protein preparation according to the invention and producing a meat based food product from the treated meat. The meat will usually be raw when being contacted with a plant protein preparation according to the invention, but may also be heat treated, precooked, or irradiated. The meat may also have been frozen before contact with a plant protein preparation according to the invention. Contacting meat with a plant protein preparation according to the invention may be done by adding a plant protein preparation according to the invention to meat. Contacting meat with a plant protein preparation according to the invention may be achieved by mixing meat, such as pieces of meat, minced meat, or a meat-based emulsion, with a plant protein preparation according to the invention and, where applicable, other ingredients used to form the meat based food product by any method known in the art. Before contact with the meat, a plant protein preparation according to the invention may be mixed with other ingredients, to form a marinade or pickling liquid, such as water, salt, flour, milk protein, vegetable protein, starch, hydrolyzed protein, phosphate, acid, spices, and mixtures thereof. The amount of a plant protein preparation according to the invention in a marinade may be adjusted as to achieve the desired final amount of a plant protein preparation according to the invention in the meat-based food product. Contacting meat, such as whole animal muscle or pieces of animal muscle, with a plant protein preparation according to the invention may be achieved by marinating and/or tumbling and/or injecting the meat with a marinade comprising a plant protein preparation according to the invention. If the meat product is a processed meat product, such as an emulsified meat product, a plant protein preparation according to the invention may be mixed into a meat-based emulsion, or into any other form of meat based mixture used to form the processed meat product.

A dairy product according to the invention may be skimmed milk, whole milk, cream, a fermented milk product, cheese, yoghurt, butter, dairy spread, butter milk, acidified milk drink, sour cream, whey-based milk drink, ice cream, a flavored milk drink, or a dessert product based on milk components such as via or custard. A dairy product may additionally comprise non-milk components, such as vegetable components including vegetable oil, vegetable protein, vegetable carbohydrates, and mixtures thereof. Dairy products may also comprise further additives such as enzymes, flavoring agents, microbial cultures, salts, sweeteners, sugars, acids, fruit, fruit juices, any other component known in the art as a component of, or additive to a dairy product, and mixtures thereof.

### EXAMPLE 1

Samples are produced by dissolving pea protein concentrate to 12% Total Solids. Sodium hydroxide is used to adjust the pH to 7.1. After neutralization, the slurry is heated to 50° C. (122° F.) and laccase is added in an amount of 0.75 LAMU/g pea protein under stirring at a temperature of 50° C. (122° F.) and allowed to react at this temperature for 30 minutes. After the enzyme reaction the sample is heated to 151.7° C. (305° F.) for 10-15 seconds. The sample is spray dried and the product is collected for use and analysis. Control samples are prepared in the same way except that inactivated enzyme are added.

The laccase treated sample has 12% higher water holding capacity than the control sample. The laccase-treated sample exhibits reduced beany aroma or pea aroma, and reduced beany taste, pea taste, or bitter taste compared with controls.

### EXAMPLE 2

The following media was produced: 58.5 g/l pea protein concentrate, 31.5 g/l rice protein concentrate, 3.6 g/l maltodextrin, 1.8 g/l carrot powder, and 0.75 g/l MAGRABAR® IP-3500, made up in water, and sterilized. Laccase (Aspergillus sp.) was obtained from Sigma-Aldrich CAS No. 80498-15-3 (0.8 U/mg) and was added at a level of 800 U/ml of 50° C. (122° F.) and was allowed to react at this temperature for 3 hours. After the enzyme reaction the sample was heated to 151.7° C. (305° F.) for 10-15 seconds. The sample was spray dried and the product was collected for use and analysis. Control samples were prepared in the same way except that inactivated enzyme were added.

The laccase treated sample had 12% higher water holding capacity than the control sample. The laccase-treated sample exhibited reduced beany aroma or pea aroma, and reduced beany taste, pea taste, or bitter taste compared with controls.

### EXAMPLE 3

RNAseq analysis was performed on the shiitake mycelia organisms L. edodes strain (Pennsylvania State University Mushroom Spawn Lab# WC 1008) which were grown in Medium A (50 g dextrose, 5 g yeast extract, 1.25 mL of olive oil/lecithin mixture (10 g of lecithin in 1 L olive oil), 0.75 g MAGRABAR® IP-3500 in 1 L of sterilized water), and subsequently transferred to Medium B (58.5 g pea protein, 31.5 rice protein, 3.6 g maltodextrin, 1.8 g carrot powder in 1 L sterilized water, 0.50 g MAGRABAR® IP-3500). L. edodes precultures were grown in shake flasks with 50 g dextrose, 5 g yeast extract, 1.25 mL of olive oil/lecithin mixture (10g of lecithin in 1 L olive oil), 20% filling volume at 26° C. and 120 rpm for 4 shake flasks across 14 days. Mycelium samples were collected from Medium A at 4 and 72 hours of growth. After an additional 72 hours of growth, 5% of each culture was transferred to a fermenter with Medium B. L. edodes mycelia equivalent to 250 mg was then harvested at 6 and 24 h of growth. After each collection, all samples were immediately frozen in liquid nitrogen and stored at −80° C. for RNA extraction. For RNA isolation and library preparation, RNA was prepared from frozen cell pellets using the Qiagen RNeasy Kit (Qiagen, Valencia, Calif.) according to the manufacturer's instructions. Sequencing libraries were validated using the Agilent Tapestation 4200 (Agilent Technologies, CA, USA), and quantified by using Qubit 2.0 Fluorometer (Invitrogen, Carlsbad, Calif.). Sequencing libraries were multiplexed and clustered on one lane of a Flow Cell. After clustering, the flow cell was loaded on the Illumina HiSeq instrument according to manufacturer's instructions. The samples were sequenced using a 2×150 Paired End (PE) configuration. Image analysis and base-calling were conducted by the HiSeq Control Software (HCS). Raw sequence data (.bcl files) generated from Illumina HiSeq were converted into Fastq files and de-multiplexed using Illumina's bcl2fastq 2.17 software. One mis-match was allowed for index sequence identification. RNA-seq was performed by GENEWIZ Plainfield (N.J., USA).

The fold-change is the amount of increase of expression of a particular gene between (A) and (B). Fastq raw sequence files from the 12 samples in the L. edodes RNAseq study were mapped and aligned to the NCBI L. edodes B17 genome assembly (available at NCBI) using Spliced Transcripts Alignment to a Reference (STAR) software (Dobin A, Davis C A, Schlesinger F, Drenkow J, Zaleski C, Jha S, et al. STAR: ultrafast universal RNA-seq aligner. Bioinformatics. 2013; 29 (1):15-21, resulting in counts of sequences per transcript. Gene level count summaries were generated using Subread's featureCounts (Liao, Y. et al. featureCounts: an efficient general purpose program for assigning sequence reads to genomic features, Bioinformatics. 2014 Apr. 1; 30 (7):923-30 across comprehensive gene annotations from Park, Sin-Gi & Yoo, Seung & Ryu, Dong & Lee, Hyunsung & Ahn, Yong & Ryu, Hojin & Ko, Junsu & Hong, Chang Pyo. (2017). Long-read transcriptome data for improved gene prediction in Lentinula edodes. Data in Brief. 15. The counts for the resulting transcripts were normalized by taking the natural log (ln) of each number and subtracting the median ln value for that sample. All zero values were converted to 0.1 prior to ln normalization to avoid undefined values for x 0. Fold change information was generated by subtracting the average ln values for the replicates of one biological group to the average ln values for the replicates of another biological group (n), which translates to a fold change of eⁿ. To generate protein-based evidence, homologous protein sequences were collected from the NCBI non-redundant (NR) database, and Exonerate was used for protein sequence alignments to produce protein-based evidence. Predicted genes were searched in the UniProt, NCBI NR and Phytozome databases using BLASTP with a cut-off E-value of 1×10−10. Protein domains were also searched using SignalP-5.0 and then assigned a probability of containing a signal peptide. Results show that the following secreted fungal enzymes are expressed at a higher level in Medium B at 24 hours of growth than in Medium A at 72 hours of growth, although all of these genes are expressed in both Medium A and B as these transcript reads are found in all samples. Table 1 shows fold-change in Medium B over Medium A, showing upregulation of the below genes.

TABLE 1

| Gene model | predicted protein | fold-change |
|---|---|---|
| GENE11460.1 | 6-hydroxy-D-nicotine oxidase | 13.93 |
| GENE14269.1 | Exoglucanase | 10.56 |
| GENE00319.1 | Exoglucanase 1 | 4.59 |
| GENE12072.1 | cytochrome p450 | 3.78 |
| GENE12833.1 | Endo-1,4-beta-xylanase C | 3.48 |
| GENE02979.1 | Benzoate 4-monooxygenase | 3.48 |
| GENE00774.2 | Endo-1,4-beta-xylanase C | 3.48 |
| GENE09363.1 | Endo-beta-1,4-glucanase D | 3.39 |
| GENE13667 | Laccase-2 | 2.83 |
| GENE14533.1 | Laccase | 2.68 |
| GENE06349 | Laccase-2 | 2.19 |
| GENE05332.1 | Beta-galactosidase | 2.25 |
| GENE02410.1 | xyloglucan-specific endo-beta-1,4- | 2.33 |
| | glucanase A | |
| GENE01099.1 | endopolygalacturonase A | 2.55 |
| GENE03068.1 | Endo-1,4-beta-xylanase C | 2.55 |
| GENE10322.1 | Glycolipid 2-alpha-mannosyltransferase 2 | 2.64 |
| GENE01084 | Beta-glucosidase A | 2.64 |
| GENE06485.1 | Glucan 1,3-beta-glucosidase | 2.64 |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for producing a plant protein product comprising treating the plant protein with at least one an exogenous enzyme comprising an oxidoreductase and/or a hydrolase, wherein the treated plant protein product has reduced undesirable flavors and reduced undesirable aromas compared to an untreated plant protein product.

2. The method of claim 1, wherein the oxidoreductase or the hydrolase is selected from the group consisting of 6-hydroxy-D-nicotine oxidase, exoglucanase, exoglucanase 1, cytochrome p450, endo-1,4-beta-xylanase C, benzoate 4-monooxygenase, endo-1,4-beta-xylanase C, endo-beta-1,4-glucanase D, laccase-2, laccase, beta-galactosidase, xyloglucan-specific endo-beta-1,4-glucanase A, endopolygalacturonase A, endo-1,4-beta-xylanase C, glycolipid 2-alpha, mannosyltransferase 2, beta-glucosidase A, glucan 1,3-beta-glucosidase, and combinations thereof.

3. The method of claim 1, wherein the exogenous enzyme is an oxidoreductase.

4. The method of claim 3, wherein the oxidoreductase is a laccase.

5. The method of claim 1 comprising adding the exogenous enzyme to a solution or suspension of plant protein, wherein the plant protein comprises plant protein isolate or plant protein concentrate.

6. The method of claim 1 comprising adding the exogenous enzyme to a solution or suspension of plant protein containing at least 50% (weight/weight) plant protein on a dry weight basis.

7. The method of claim 1 wherein at least one the exogenous enzyme is added in an amount sufficient to increase the viscosity of a solution or suspension of the plant protein or increase the water holding capacity and/or water binding of a solution or suspension of the plant protein.

8. The method of claim 1 further comprising heating the treated plant protein to a temperature and for a time sufficient to inactivate the exogenous enzyme.

9. The method of claim 1, wherein the plant protein comprises pea protein, rice protein, or combinations thereof.

10. The method of claim 9, wherein the plant source comprises pea.

11. The method of claim 9, wherein the plant source comprises rice.

12. The method of claim 1, wherein the method further comprises the step of drying the plant protein product.

13. The method of claim 1, wherein the reduced undesirable flavor is a pea flavor or a bitterness flavor.

14. The method of claim 1, wherein the reduced undesirable aroma is a beany aroma or a rice aroma.

15. The method of claim 1 further comprising preparing a food product with the treated plant protein.

16. A plant protein product obtainable by the method claim 1.

17. The method of claim 1, wherein the method further comprises combining the treated plant protein product with another material to create a food product.

18. The method of claim 17 wherein the food product is selected from the group consisting of a meat substitute product, a dairy product, a vegetable product, a fruit product, a ready to eat product, and mixtures thereof.

19. The method of claim 18 wherein the food product is a meat substitute product.
